(19) United States
(12) Patent Application Publication
(10) Pub. No.: US 2008/0021619 A1
(43) Pub. Date: Jan. 24, 2008

(54) Device For Actuating An Electric Or Mechanical Closing Device On A Door And/Or Lid Of A Vehicle

(76) Inventors: Bearnd Steegmann, Heiligenhaus (DE); Martin Witte, Ahaus (DE); Mirko Schindler, Velbert (DE); Helmut Klein, Velbert (DE)

Correspondence Address: FRIEDRICH KUEFFNER, 317 MADISON AVENUE, SUITE 910, NEW YORK, NY, 10017, US

(21) Appl. No.: 11/597,861

(22) PCT Filed: May 21, 2005
(86) PCT No.: PCT/EP05/05540

§ 371 Date: Nov. 28, 2006

(30) Foreign Application Priority Data
May 29, 2004 (DE) 10 2004 026 442.2

(51) Int. Cl. E05B 65/20; E05B 47/00; G05B 15/00

(52) U.S. Cl. 701/49; 70/276; 701/36

(57) ABSTRACT

The invention relates to a device for actuating an electric or electromechanical closing device (10) on a door (12) and/or a lid of a vehicle, said device comprising a sensor that reacts to an approach or contact. The aim of the invention is to provide a device that can clearly differentiate between the triggering of the sensor by a real human hand or by an erroneous object. To achieve this, a two-part auxiliary sensor (50), which consists of a permanent magnet (52) and a Hall element (51), is positioned in addition to the primary sensor (40) in the contact area of a handle (20). One part of the auxiliary sensor (50), e.g. the Hall clement (51), is situated on the displaceable handle (20) and the other part, namely the permanent magnet (52), on the fixed carrier (11). During a displacement (23) of the Hall clement (51) in relation to the permanent magnet (52), a signal is generated both in the auxiliary sensor (50) and the primary sensor (40), said signals being evaluated in common. Upon completion of the evaluation, an output signal is emitted, transferring the lock (30) into the locking position in which an actuation (23) of the handle (20) is ineffective.

The invention pertains to an arrangement of the type indicated in the introductory clause of claim 1. The sensor of the arrangement responds to approach or to contact.

To provide increased operating convenience, it is known (DE 196 17 938 C2) that a capacitive sensor which responds only when an authorized person approaches it, can be provided in a closing device of a vehicle, this sensor being integrated into the grip of the external door handle. As a function of an authorization check, this capacitive sensor serves to actuate the closing device and to grant access to the vehicle. In this known arrangement, the authorized person carries an identification transmitter (ID transmitter). When his or her hand approaches the handle, the capacitance of the capacitive sensor changes, and a signal is sent to the electronic control system in the vehicle. The control system uses a sending and receiving arrangement to initiate the search procedure for the ID transmitter, and data communications begin between the ID transmitter and the electronic control system. The ID transmitter transmits an identification code, and if the person in question is authorized, the electronic control system arrives at a positive code comparison, and the closing device allows access to the vehicle. The actuation function of the closing device is switched to an active state even before the handle of the closing device is in fact actuated by the authorized person. The person who actuates the handle notices nothing of these communications or of this data comparison. The door or hatch is opened and closed without any delay.

So that no unnecessary, energy-consuming communication takes place, a sensor should not respond to the approach of, or to contact by, any object at all, but rather only to the approach of, or to contact by, a human hand. It is undesirable for any random external influence such as rain, snow, ice, or leaves to result in the actuation of the device. For this reason, the speed at which the capacitance changes when an object approaches or makes contact is also determined in another known closing device with a capacitive sensor (DE 196 20 059 Al). In this known device, use is made of the circumstance that the change in capacitance per unit time is greater upon the approach of a human hand to the sensor than upon the approach of foreign objects. When the change in capacitance per unit time is measured, the actuation function of the closing device is switched to an active state only if the change in capacitance over time exceeds a certain limit value. This method cannot be used in all cases, however.

The invention is based on the task of developing a reliable arrangement of the type indicated in the introductory clause of claim 1, which differentiates clearly between actuation of the sensor by a human hand and actuation by foreign objects and which accordingly renders the actuation function of the closing device either active or inactive. This is achieved according to the invention by the measures cited in claim 1, to which the following special meaning attaches.

When the handle is actuated, not only a main sensor but also an auxiliary sensor, which consists of a permanent magnet and a Hall element, responds to this contact. One of these two elements is located in the movable handle, the other in the adjacent, stationary bracket. Although the two sensors transmit separate signals when actuation occurs, the two signals are evaluated jointly. The auxiliary sensor transmits a signal because the actuation of the handle causes a vertical and/or horizontal relative movement between the Hall element and the permanent magnet. This produces signals in the Hall sensor. If the evaluation is successful, the lock is switched to its locked position if had previously been in its unlocked position. In the locked position, actuating the handle has no effect; the door or hatch cannot be opened. These measures can be used in two different ways.

Because both signals are necessary for a successful evaluation, there is no danger that the closing device could be actuated mistakenly in the invention in the manner described above. It is not enough for the main sensor to detect the approach of an object and to transmit a signal. It is also necessary for a relative movement of the Hall element versus the permanent magnet to occur simultaneously or at least within a certain time window, so that the auxiliary sensor also transmits a signal. After the two signals have been evaluated, a common output signal is generated and sent to a control unit in the vehicle. If the output signal is based on a successful evaluation of the two signals, the control unit switches the lock, several of the locks, or all of the locks in the vehicle.

According to the invention, not only the main sensor but also the auxiliary sensor operates dynamically. Thus the duration of the contact or of the approach can be detected and evaluated by both sensors. The common output signal resulting from the evaluation of the two signals can then be used not only for the previously described switching of the lock but also for initiating one or-more other functions in the vehicle. Whether such functions are initiated and the nature of those functions depend on the duration of the contact. These additional functions can involve the actuation of movable parts associated with convenience. As a result, opened windows of the vehicle can be closed, an alarm system can be turned on, a roof panel in the vehicle can be closed, and/or side mirrors can be retracted.

Additional measures and advantages of the invention can be derived from the subclaims, from the following description, and from the drawings. The drawings illustrate the invention schematically on the basis of an exemplary embodiment:

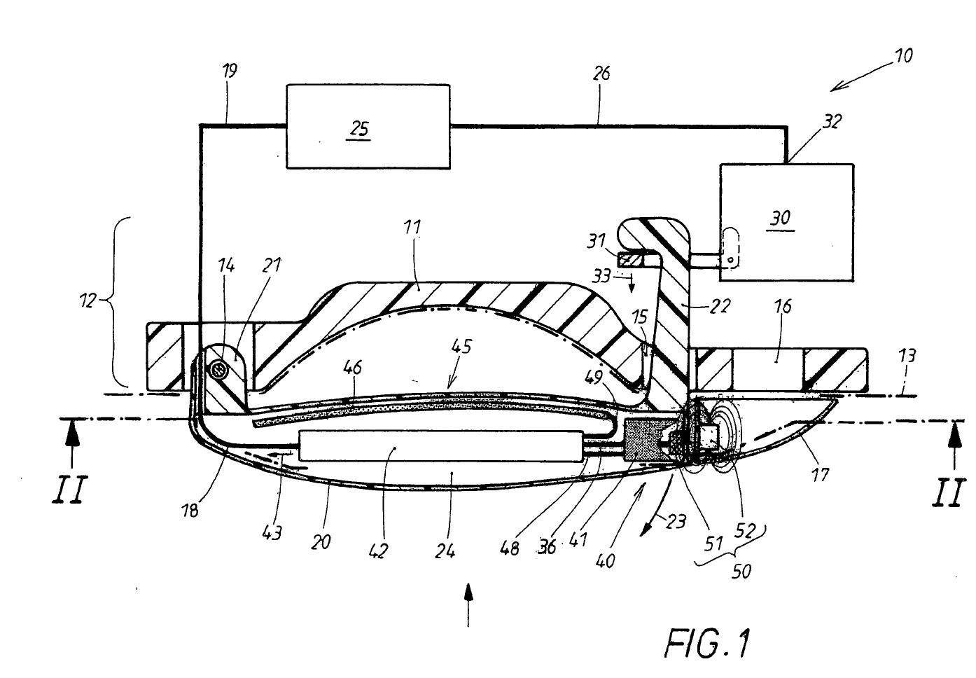

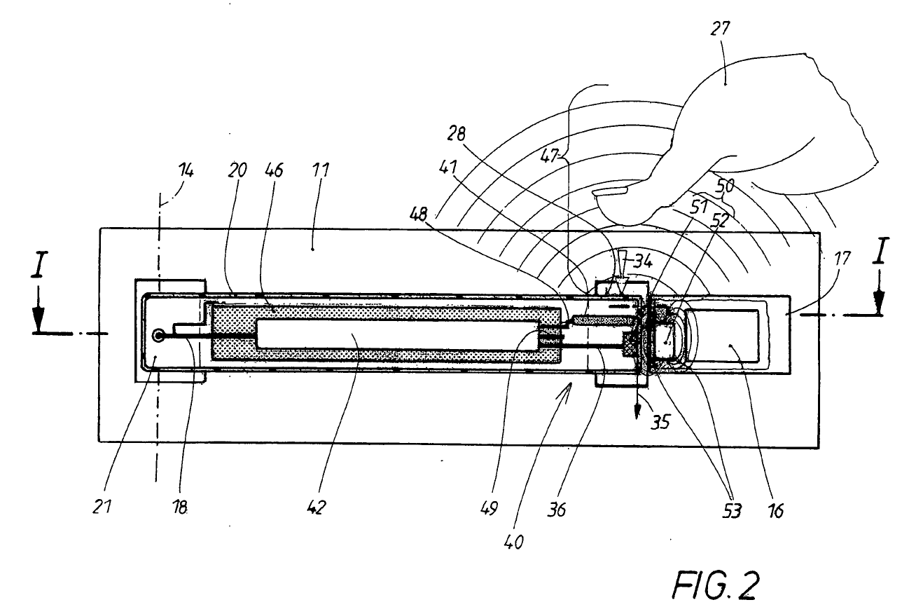

FIG. 1 shows an essentially horizontal longitudinal cross section through an external door handle of a vehicle in which the inventive arrangement is realized; the viewing direction is indicated by the cross-sectional line I-I of FIG. 2; and

FIG. 2 shows a vertical longitudinal cross section through the external door handle shown in FIG. 1 along the cross-sectional line II-II in that figure.

The closing device 10 used in the inventive arrangement comprises a bracket 11, which is mounted in the interior of a door 12 of a vehicle (not shown). Only the exterior panel 13 of the door 12 is shown in dash-dot line.

The closing device 10 also includes a handle 20. One end 21 of the handle 20 is supported pivotably in the bracket 11. The axis 14 of the pivot bearing is essentially vertical with respect to the door 12, for which reason the handle 20 is a so-called “pull-handle”. The other end 22 of the handle 20 has an extension with a hook at the end. The extension passes through an opening 15 in the exterior door panel 13 and in the bracket 11. The hooked end of the extension grips a mechanical input element 31 on a lock 30 installed in the door 12.

The lock 30 normally holds the door 12 in its closed position. The lock 30 can be in either one of two different operating positions, as desired, namely, a locked position and an unlocked position. When the handle 20 is pivoted in the direction of the arrow 23 in FIG. 1, the extension 22 carries the lock element 31 along with it in the direction of the arrow 33 in FIG. 1. When the lock 30 is in the unlocked position, this actuation 23 of the handle 20 is functionally effective. The lock 30 thus releases the door, and the door 12 can be opened. If, however, the lock 30 is in the locked position, the actuation 23 is not functionally effective; the lock element 31 is carried along in a “nonactive” manner, and the lock 30 thus does not release the door. In spite of the actuation 23, the lock 30 remains locked in its closed position. The door remains closed.

In an emergency, the lock 30 can be switched from one state to another mechanically, e.g., by the use of a lock cylinder. Although this is not shown in detail, another opening 16 in the bracket 11 and in the exterior door panel 13 can be seen, in which a lock cylinder of this type could be installed. The lock cylinder can be actuated by an emergency key. The front end of the lock cylinder, where the key can be inserted and removed, can be integrated into a cover piece 17, which is attached to the bracket 11 and which is designed so that it is flush with the handle 20.

In the normal case, the lock 30 is switched between the unlocked position and the locked position by electrical means. For this purpose, the lock 30 has an electrical input 32. The three sensors 40, 45, and 50, which have various functions to be described in greater detail later, are the initiators of this electrical switching of the lock 30. Electronic components 42, which are used for operations, for control, and/or for evaluating and combining the signals coming from the three sensors 40, 45, 50, are also installed in the interior 24 of the handle.

Two of these sensors 40, 45 in the present case act on the basis of capacitance. The electrodes 41, 46 of these sensors are indicated in the figures by different types of shading. The electrodes 41, 46 cooperate with the body of the vehicle and/or the environment to build up an electrical field. A field 47 of the capacitive sensor 40 is suggested in FIG. 2 by field lines. When an object such as a finger 27 shown by way of example in FIG. 3 arrives in one of the electrical fields generated by the electrodes 41, 46, the capacitance between the electrodes 41, 46 and the vehicle or its environment changes. This is registered and evaluated by the associated electrical evaluation units 42 in different ways, which will be described in greater detail later.

If the evaluation is successful, the associated components 42 transmit an output signal, illustrated by an arrow 43 in FIG. 1, which is sent over electric lines 18 in the area of the handle 20 and over an extension of those lines in the form of an electric cable 19 in the door 12 and in the vehicle to a control unit 25. This can be a central control unit 25, which acts on the various locks 30 in the various doors and hatches of the vehicle by way of numerous electrical or mechanical connections 26 between it and the locks. The electrical connection 26 is connected to the previously mentioned electrical input 32 of the lock 30 in question. Instead of an electrical connection 26, the control unit 25 could also act mechanically on a second input element (not shown) of the lock 30.

The two capacitive sensors 40, 45 act independently of each other and work in ways which differ from each other. One capacitive sensor 45 is set to a very high sensitivity and acts in the known manner upon the approach of an object, especially of an authorized person. This sensor 45 is used to release a locked lock 30 and thus, as previously described, to make it possible to actuate 23 the handle 20 successfully. This takes place, however, only if the following additional condition is satisfied:

One such additional condition for the switching of the lock 30 is derived from the circumstance that access to the vehicle is to be granted only to authorized persons, not to someone without such proper authorization. The authorized person carries an identification transmitter, referred to in the following in brief as an “ID transmitter”, for which a corresponding identification receiver, called in a similar manner the “ID receiver”, is provided in the vehicle. Normally, an ID transmitter of this type is passive. It works when the authorized person simply approaches the vehicle. There is no need for the person to perform any action on the ID transmitter or with the ID transmitter. It is also conceivable, however, that an active ID transmitter could be used, such as an electronic remote-control key, which, in order to become active, must be activated by a button.

In both cases, one-way or two-way communication takes place with the ID receiver. If these communications are successful, the successful outcome is reported to the control unit 25, which also receives the additional condition required for switching. By way of the previously mentioned electrical or mechanical connection 26, the control unit then switches the lock 30 to its previously mentioned unlocked position. When then the handle 20 is now actually moved in the direction of the arrow 23 in FIG. 1, the lock 30 releases the door 12. The door can be opened. For this reason, this second capacitive sensor 45 is to be called the “opening sensor”.

The previously mentioned first capacitive sensor 40 is made less sensitive than the opening sensor and is to be referred to in the following as the “main sensor”. The main sensor 40 acts only in coordination with the previously mentioned third sensor 50, which is to be called the “auxiliary sensor”. This auxiliary sensor 50 has a two-part design and consists of a Hall element 51 and a permanent magnet 52. The permanent magnet generates a magnetic field 53, illustrated in the figures by field lines, in the area where the Hall element 51 is located. Whereas the Hall element 51 is located close to the end wall of the interior space 24 of the handle 20, the permanent magnet 52 is located on the inside surface of the adjacent wall of the previously mentioned cover piece 17.

When the previously mentioned human hand 27 touches, for example, the contact area designated 28 in FIG. 2, not only the main sensor 40, as previously mentioned, but also the auxiliary sensor 50 responds. That is, the contact has the result of effecting relative movement between the handle 20 and the bracket 11. This movement can occur either on the basis of the bearing 14 or because of play in this support area. Vertical and/or horizontal movements can result from the contact. This is illustrated in FIG. 2 by a force arrow 34; pressure is exerted by the finger 27 on the contact point 28. As a result, the relative movement of the Hall element 51 in the resting magnetic field 53 of the permanent magnet 52 takes place as indicated by the motion arrow 35 in FIG. 2. An electrical signal is thus generated in the Hall element 51, and this signal is sent over the electrical connection 36 to the evaluation units 42 in the handle 20. The analogous electrical connections 48, 49 between the electrodes 41, 46 and the evaluation units 42 are also indicated in FIG. 2.

Because of its long-distance capacitive sensitivity, the main sensor 40 becomes active upon the mere approach of the finger, but certainly no later than the time at which the finger makes actual contact with the actuating point 28 in FIG. 2. Then, although the main and auxiliary sensors transmit their own independent signals to their control and evaluation units 42, the two signals are evaluated jointly. Only if the evaluation units 42 find both signals to be correct is an output signal 43 generated, which, as previously mentioned, is sent to the control unit 25. In the event of a successful evaluation, the control unit 25 switches the lock 30 to its locked position, as previously described.

Both the main sensor and the auxiliary sensor operate dynamically. Thus the duration of the contact or approach can be detected and evaluated by both sensors. The duration of the contact is determined by the auxiliary sensor and results in a correspondingly modified output signal 43. As a function of the contact duration, it is then possible, in addition to the previously mentioned switching of the lock 30, for one or more other functions in the vehicle to be initiated. The initiation of so-called “convenience” functions by which certain movable parts in the vehicle are moved is especially advantageous. The types of convenience functions which can be initiated have already been mentioned by way of example above.

### LIST OF REFERENCE NUMBERS

10 device, closing device
11 bracket
12 door
13 exterior panel of 12
14 pivot bearing of 20 on 11
15 opening in 11 for 22
16 opening in 11 for a lock cylinder
17 cover piece of 11
18 electric line for 43 in 20
19 electric cable for 43
20 handle
21 first end of 20
22 second end of 20
23 arrow of the pivoting movement of 20, actuation
24 interior of 20, empty space
25 control unit
26 electrical connection
27 human finger (FIG. 2)
28 actuating area
30 lock
31 mechanical input element of 30, lock element
32 electrical input of 30
33 arrow of the carry-along movement of 31
34 force arrow of 27 on 28 (FIG. 2)
35 motion arrow of 20 (FIG. 2)
36 electrical connection between 51 and 42 (FIG. 2)
40 first sensor for the locking of 30, main sensor
41 electrode of 40
42 electrical components, evaluation units for 40, 50, 45
43 arrow of an electrical output signal of 42 to 25 (FIG. 1)
45 second capacitive sensor for the unlocking of 30, opening sensor
46 electrode of 45
47 electrical field of 40 (FIG. 2)
48 electrical connection of 41 to 42
49 electrical connection of 46 to 42
50 auxiliary sensor
51 Hall element of 50
52 permanent magnet of 50
53 magnetic field of 52

1. Arrangement for actuating an electrical or electromechanical closing device (10) on a door (12) and/or a hatch of a vehicle,
with a handle (20), which is used to open and/or to close a lock (30) provided on the door (12) and/or hatch,
where the handle (20) is supported in a bracket (10), which is attached to the door (12) or hatch,
with at least one sensor, which, upon approach or contact, switches the lock (30) between an unlocked position and a locked position,
where, in the unlocked position, the actuation of the handle (20) is functionally effective for the lock (30) but is not functionally effective in the locked position,
wherein
in addition to a main sensor (40), a two-part auxiliary sensor (50), consisting of a permanent magnet (52) and a Hall element (51), is located in the contact area (28); wherein
one part of the auxiliary sensor (50), namely, the Hall element (51) or the permanent magnet (52), is mounted on the movable handle (20), whereas the other part, namely, the permanent magnet (52) or the Hall element (51), is seated on the stationary bracket (11); wherein
although the main and auxiliary sensors (40, 50) transmit separate signals upon a vertical and/or horizontal movement (23) of the handle (20) with respect to the bracket (10), the two signals are evaluated (42) jointly; and wherein
a successful evaluation (42) of the two signals switches the lock (30) to its locked position.

2. Arrangement according to claim 1, wherein, after the evaluation of the two signals, a joint output signal (43) is generated and sent to a control unit (25) in the vehicle; and wherein
by means of an output signal (43) which characterizes a successful evaluation, the control unit (25) switches the state of at least one of the locks (30) in the vehicle.

3. Arrangement according to claim 1, wherein the main sensor (40) acts on the basis of capacitance and has at least one electrode (41); and in that
the electrode (41) is connected to electrical components (42) for controlling the main sensor and/or for evaluating the signals.

4. Arrangement according to claim 1, wherein the Hall element (51) of the auxiliary sensor (50) is located next to the electrode (41) of the main sensor (40).

5. Arrangement according to claim 1, wherein the Hall element of the auxiliary sensor and the electrode of the main sensor are located in the handle of the closing device.

6. Arrangement according to claim 5, wherein at least one electrical component (42) for operations, for control, and/or for evaluation of the signals from the main and/or auxiliary sensor (40, 50) is located in the handle (20).

7. Arrangement according to claim 1, wherein the permanent magnet (52) of the auxiliary sensor (50) is located under a cover piece (17), which is positioned next to the handle (20) of the closing device (10).

8. Arrangement according to claim 1, wherein, when contact is made with the handle (20), the Hall element (51) moves relative to the permanent magnet (52), as a result of which a short signal is transmitted by the Hall element, which also registers the duration of the contact; and in that
as a function of the duration of contact, one or more additional functions in the vehicle are initiated in addition to the switching of the lock (30).

9. Arrangement according to claim 8, wherein the additional functions in the vehicle are convenience functions involving movable parts in the vehicle.

10. Arrangement according to claim 9, wherein the convenience functions consist in that at least one opened window in the vehicle is closed and/or an alarm system is turned on and/or a roof panel in the vehicle is closed and/or the side mirrors of the vehicle are retracted.

11. Arrangement according to claim 1, wherein, in addition to the main and auxiliary sensors (40, 50), an opening sensor (45) is also provided, which switches the lock (30) to its unlocked position upon approach or contact.

12. Arrangement according to claim 11, wherein the opening sensor (45) is located in the handle (20) of the closing device (10).

13. Arrangement according to claim 11, wherein at least one electrical component (42) for operations, for control, and/or for evaluation of the signals coming from the opening sensor (45) is located in the handle (20).

14. Arrangement according to claim 1, wherein the control unit (25) initiates the switching of the lock (30) between the locked position and the unlocked position only if contact takes place between an authorized person and the main and auxiliary sensors (40, 50).

15. Arrangement according to claim 14, wherein the authorized person carries an active or passive identification transmitter (ID transmitter) on his/her person; in that
the ID transmitter communicates with an identification receiver (ID receiver) in the vehicle; and in that
if the communication between the ID transmitter and the ID receiver is successful, the device (10) is released for actuation (23).
